(19) United States
(12) Patent Application Publication
(10) Pub. No.: US 2018/0051186 A1
(43) Pub. Date: Feb. 22, 2018

(54) ADHESIVE, DISPLAY DEVICE AND PRODUCTION METHOD OF ADHESIVE

(71) Applicants: BOE Technology Group Co., Ltd., Beijing (CN); Hefei Xinsheng Optoelectronics Technology Co., Ltd., Anhui (CN)

(72) Inventors: Huan Ni, Beijing (CN); Fengzhen Lv, Beijing (CN); Xinxia Zhang, Beijing (CN); Xiao Guo, Beijing (CN); Xiaolong Xie, Beijing (CN); Mingguang Li, Beijing (CN); Qun Li, Beijing (CN); Chengpeng Yao, Beijing (CN)

(21) Appl. No.: 15/659,010

(22) Filed: Jul. 25, 2017

(30) Foreign Application Priority Data
Aug. 16, 2016 (CN) 201610671736.0

(51) Int. Cl. C09J 5/00; C09J 9/00

(52) U.S. Cl. CPC C09J 5/00; C09J 9/00; C09J 2205/31; C09J 2463/00; G02F 1/1339; C09J 2433/00; G02F 2202/025; G02F 2202/28; C09J 2431/00

(57) ABSTRACT

The present disclosure relates to an adhesive, a display device and a production method for the adhesive. The adhesive comprises an adhesive substrate, wherein the adhesive further comprises a capsule, which capsule comprising a restoration agent and a capsule wall surrounding the restoration agent.

### CROSS-REFERENCE TO RELATED APPLICATIONS

This application is a non-provisional application which claims priority to Chinese Patent Application No. 201610671736.0, filed on Aug. 16, 2016, with SIPO, the content of which is hereby incorporated by reference in its entirety.

### TECHNICAL FIELD

The present disclosure relates to the field of display technology. More specifically, the present disclosure relates to an adhesive, a display device and a method for producing the adhesive.

### BACKGROUND ART

In a display, for example, a liquid crystal display, at the periphery of the upper substrate and the lower substrate thereof, it is necessary to bond the upper glass to the lower glass together via a seal agent, so as to keep a certain distance between the upper substrate and the lower substrate and to prevent the leakage of the liquid crystal and the entrance of external contaminants. The seal agent mainly consists of a UV curing resin or a thermocuring resin, corresponding to a UV curing treatment and a thermocuring treatment, respectively.

However, during the practical utilization of a display device, local microdamages tend to occur in the seal agent, affecting the reliability of the seal agent. Moreover, during the reliability test of a display device, the pressure on the peripheral region of the screen may result in the occurrence of crack in the seal agent, leading to issues such as poor reliability.

### SUMMARY

An objective of the present invention is to provide an adhesive.

The first aspect of the present invention provides an adhesive comprising an adhesive substrate, wherein the adhesive further comprises a capsule comprising a restoration agent and a capsule wall surrounding the restoration agent.

In an example, the adhesive further comprises a catalyst provided in the adhesive substrate, which catalyst is used for catalyzing a polymerization reaction of the restoration agent.

In an example, the restoration agent includes at least one of an epoxy resin, a vinyl ester resin, polymethyl methacrylate, and cyclopentadiene.

In an example, the capsule wall comprises a urea-aldehyde resin.

In an example, the capsule further comprises a fluorescence material.

In an example, the fluorescent material comprises an organic fluorescent material.

In an example, the organic fluorescent material comprises at least one of fluorescein, Nile red, and an aggregation-induced emission fluorescent compound.

In an example, the adhesive substrate comprises a resin, an oligomer, a photoinitiator, and a curing agent.

In an example, the curing agent has a mass percentage of 0.1 to 5 wt % in the adhesive.

In an example, the capsule has a mass percentage of 0.5 to 15 wt % in the adhesive.

In an example, the capsule has a particle size ranging from 10 to 100 nm.

Another objective of the present invention is to provide a display device.

The second aspect of the present invention provides a display device comprising the adhesive described above.

In an example, the display device comprises a first substrate and a second substrate provided oppositely as well as the adhesive provided between the first substrate and the second substrate.

Yet another objective of the present invention is to provide a production method of an adhesive.

The third aspect of the present invention provides a production method of an adhesive, comprising:

forming an adhesive substrate, and

providing a capsule in the adhesive substrate, which capsule comprises a restoration agent and a capsule wall surrounding the restoration agent.

In an example, the method further comprises incorporating a catalyst into the adhesive substrate, which catalyst is used for catalyzing a polymerization reaction of the restoration agent.

In an example, the capsule further comprises a fluorescent material, and wherein providing a capsule in the adhesive substrate comprises:

forming the capsule; and

incorporating the capsule into the adhesive substrate.

In an example, forming the capsule comprises:

forming an emulsion comprising a capsule wall prepolymer, an emulsifier, a restoration agent, and a fluorescent material;

performing a curing treatment; and

performing a separation treatment.

In an example, performing a curing treatment comprises:

adding a thermocuring agent; and

curing for 2 to 3 hours under a condition of 60° C.

In an example, performing a curing treatment comprises:

adding a photocuring agent; and

curing for 15 to 30 minutes under a condition of ultraviolet irradiation.

In an example, forming the capsule comprises applying an in-situ emulsion method.

In an example, the fluorescent material comprises an organic fluorescent material.

In an example, the restoration agent comprises at least one of an epoxy resin, a vinyl ester resin, polymethyl methacrylate and cyclopentadiene;

the capsule wall prepolymer comprises a urea-aldehyde resin prepolymer; and

the organic fluorescent material comprises at least one of fluorescein, Nile red, and an aggregation-induced emission fluorescent compound.

### BRIEF DESCRIPTION OF FIGURES

In order to illustrate the technical solutions of examples of the present invention more clearly, the figures of the examples will be described briefly below. It should be known that the description of the figures below merely relates to some examples of the present invention, rather than the limitation to the present invention, wherein:

FIG. 1 is a schematic diagram of components of an adhesive according to an example of the present invention;

FIG. 2 is a schematic diagram of components of an adhesive according to another example of the present invention;

FIG. 3 is a schematic diagram of components of an adhesive according to another example of the present invention;

FIG. 4 is a flow chart showing a production method of an adhesive according to an example of the present invention;

FIG. 5 is a flow chart showing a production method of an adhesive according to an example of the present invention;

FIG. 6 is a flow chart showing a production method of an adhesive according to the example of the present invention;

FIG. 7 (a) is a schematic diagram of a display device according to an example of the present invention;

FIG. 7 (b) shows the situation that the adhesive of the display device is damaged;

FIG. 7 (c) shows the situation that the damage in the adhesive of the display device is restored.

### DESCRIPTION OF THE PREFERRED EMBODIMENTS

To make the objective, technical solution and advantages of the examples of the present invention more clearly, the technical solution of the example in the present invention will be described clearly and completely below, with reference to the figures. Obviously, the described examples are some examples of the present invention, not all of them. All other examples obtained by those skilled in the art without the exercise of inventive skill, based on the described examples in the present invention, also fall into the scope of the present invention.

When introducing the elements and their examples in the present disclosure, “a”, “an”, “the” and “said” are aimed to represent there are one or more element(s). The terms “comprise”, “include”, “contain” and “have” are aimed to be inclusive and represent that there may be other elements in addition to the listed elements.

For the purpose of surface description below, as orientated in the figures, terms “up”, “down”, “left”, “right”, “perpendicular”, “horizontal”, “top”, “bottom” and the derivative terms thereof should relates to the invention. The terms “overlying”, “on the top of . . . ”, “locate on . . . ” or “locate on the top of . . . ” means that a first element such as a first structure is above a second element such as a second structure, wherein there may be an intermediate element such as an interface structure between the first element and the second element. The term “contact” means to connect the first element such as first structure and the second element such as the second structure, and there may be or may be no other elements at the interface of the two elements.

The examples of the present invention provide an adhesive, a display device and a method for producing the adhesive, which may solve at least some of the technical problems in the prior art such as the easy occurrence of tropical damage in the adhesive of the seal agent that results in the reduction of the reliability.

The adhesive, the display device and the production method of the adhesive provided in examples of the present invention may allow the self-restoration of the damage in the adhesive, such as a seal agent, and may improve the reliability of the adhesive, by forming an adhesive substrate, and providing a capsule in the adhesive substrate, which capsule comprises a restoration agent and a capsule wall surrounding the restoration agent.

FIG. 1 is a schematic diagram of components of an adhesive according to an example of the present invention. As shown in FIG. 1, the adhesive comprises an adhesive substrate 1 and a capsule, wherein the capsule comprises a restoration agent 21 and a capsule wall 22 surrounding the restoration agent 21.

It needs to be pointed out that the round shape of the capsule as shown in the figure is simply exemplary. The capsule may be of any shape, e.g., sphere, ring or an irregular deformed shape. The surface of the capsule may be of any texture, e.g., rough or smooth. The distribution and the number of the capsules in the adhesive is also only exemplary, they may be distributed in the adhesive uniformly or unevenly.

The restoration agent may comprise at least one of an epoxy resin, a vinyl ester resin, polymethyl methacrylate and cyclopentadiene. However, restoration agent may also comprise any other materials suitable for restoration agent, which is not limited in the present disclosure. As the material of the capsule wall, a urea-aldehyde resin may be selected, and other materials suitable for separating the adhesive substrate and the restoration agent may also be selected.

When a crack generated in the adhesive extends to the surface of the capsule and makes the capsule break, due to the siphonage of a capillary, the restoration agent, such as monomers, may reach the crack of the adhesive, where reaction such as polymerization reaction of the restoration agent is initiated, thereby restoring the crack, allowing the property of the adhesive to be recovered to some extent.

FIG. 2 is a schematic diagram of components of an adhesive according to another example of the present invention. As shown in FIG. 2, the adhesive further comprises a catalyst 3 provided in the adhesive substrate. The catalyst is used for catalyzing the polymerization reaction of the restoration agent, such as monomers. The shape and the number of the catalyst in the figure are only exemplary, and the catalyst may be distributed in the adhesive uniformly or unevenly.

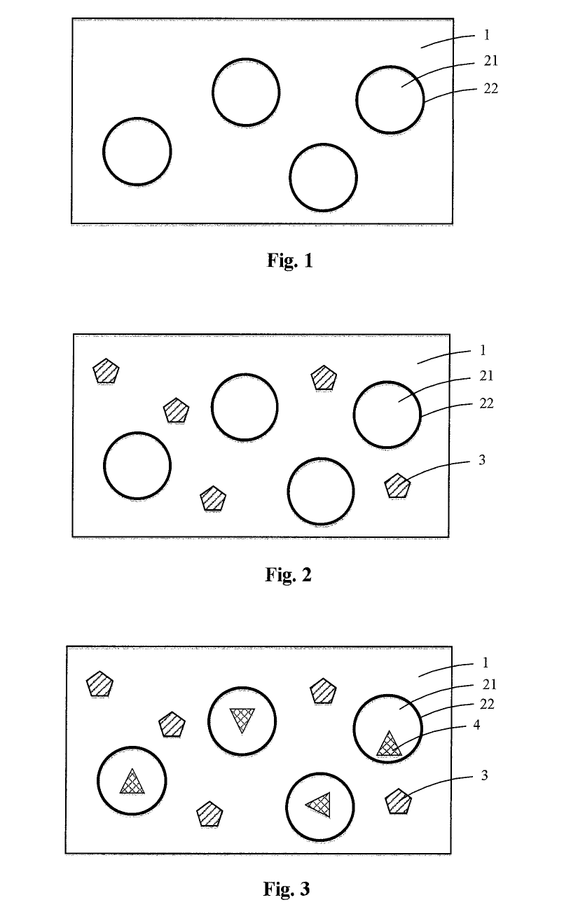

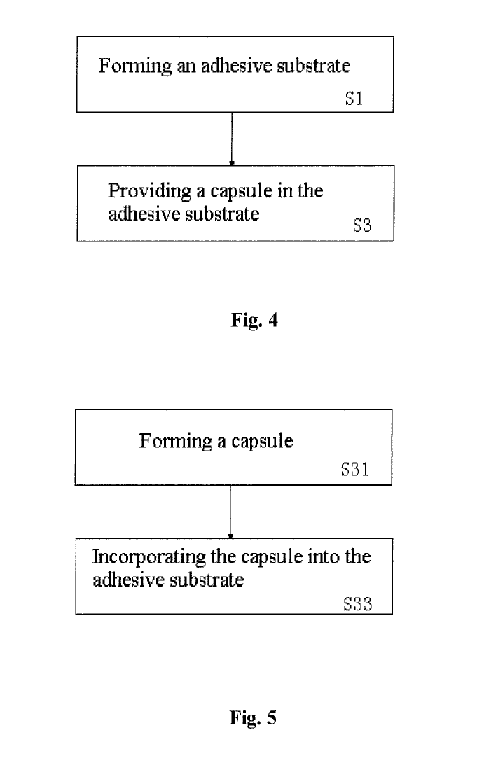

FIG. 3 is a schematic diagram of components of an adhesive according to another example of the present invention. As shown in FIG. 3, the capsule further comprises a fluorescent material 4. The shape and the number of the fluorescent material in the figure are only exemplary, and the fluorescent material may be distributed in the capsule uniformly or unevenly. On the basis of the fluorescence variation of the adhesive, the damage position and the restoration of the adhesive may be detected, the occurrence points of stress may be detected, and the reliability of the adhesive may also be assessed.

In view of better dissolution into the restoration agent, the fluorescent material may comprise an organic fluorescent material having good miscibility with the restoration agent. For example, the organic fluorescent material may comprise at least one of fluorescein (C₂₀H₁₂O₅), Nile red (C₂₀H₁₈N₂O₂) and an aggregation-induced emission (AIE) fluorescent compound. The molecular formula of fluorescein is as follows:

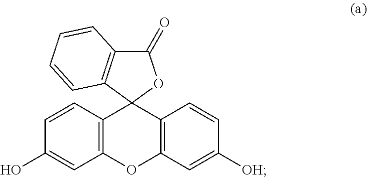 [SMILES: O=C1OC2(c3ccc(O)cc3Oc3cc(O)ccc32)c2ccccc21]

the molecular formula of Nile red is as follows:

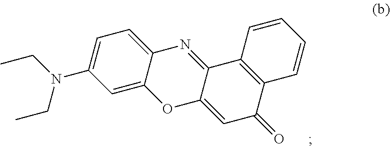 [SMILES: CCN(CC)c1ccc2nc3c4ccccc4c(=O)cc-3oc2c1]

and the aggregation-induced emission fluorescent compound may be 4-(methylene ethylene oxide)-tetraphenyl ethylene (C₂₉H₂₄O), and the molecular formula thereof is as follows:

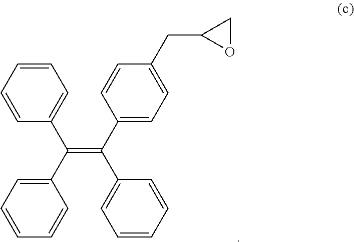 [SMILES: c1ccc(C(=C(c2ccccc2)c2ccc(CC3CO3)cc2)c2ccccc2)cc1]

In the case of using the aggregation-induced emission compound, AIE exhibits no fluorescence emission or weak fluorescence emission when it is in the capsule. Once the capsule breaks, the restoration agent such as monomers and the fluorescent material would leak out from the capsule due to siphonage, and the restoration agent would be cured under the catalysis by the catalyst; and at this time, the AIE molecule is in the state of aggregation. Because of the space constraint, the intramolecular rotation of AIE is limited, the nonradiative energy falling is suppressed, such that the molecule in an excitation state has to fall back to the ground state in a radiative form, thereby enhancing the fluorescence representing a strong fluorescence emission state. Thus, it is possible to judge the damage position and the restoration and detect the occurrence points of stress by observing the variation of the fluorescence strength.

The adhesive substrate may comprise a resin, an oligomer, a photoinitiator and a curing agent. The adhesive substrate may comprise a photocurable (e.g., by ultraviolet light UV) resin and/or a thermocuring resin, corresponding to a photocuring (e.g., by UV) treatment and/or a thermocuring treatment, respectively. Through a treatment, such as UV irradiation and/or hot blast furnace heating, the internal components thereof chemically reacted, forming stable steric bridge structure. Thereby it has enough bond strength, and thus may be used in a thin-film transistor (TFT) substrate and a color filter (CF) substrate, etc.

In an example, the mass percentage of the curing agent in the adhesive is 0.1 to 5 wt %. In an example, the mass percentage of the capsule in the adhesive is 0.5 to 15 wt %.

Herein, the maximum of the linear distance between any two points on the surface of a capsule is defined as the “particle size” of capsule. It may be appreciated that when the capsule is a sphere, the particle size is the diameter of the sphere. In an example, the particle size of the capsule ranges from 10 to 100 nm.

The example of the present invention provides a production method of an adhesive.

FIG. 4 is a flow chart showing the production method of the adhesive according to the example of the present invention. As shown in FIG. 4, the production method of the adhesive comprises:

S1. Forming an adhesive substrate;

S3. Providing a capsule in the adhesive substrate, wherein the capsule comprises a restoration agent and a capsule wall surrounding the restoration agent.

Further, the production method of the adhesive according to the example of the present invention further comprises incorporating a catalyst into the adhesive substrate, wherein the catalyst is used for catalyzing the polymerization reaction of the restoration agent. In an example, the capsule further comprises a fluorescent material.

FIG. 5 is a flow chart showing the production method of an adhesive according to an example of the present invention. As shown in FIG. 5, in an example, step S3 for providing a capsule in the adhesive substrate may comprises:

S31. Forming a capsule;

S33. Incorporating the capsule into the adhesive substrate.

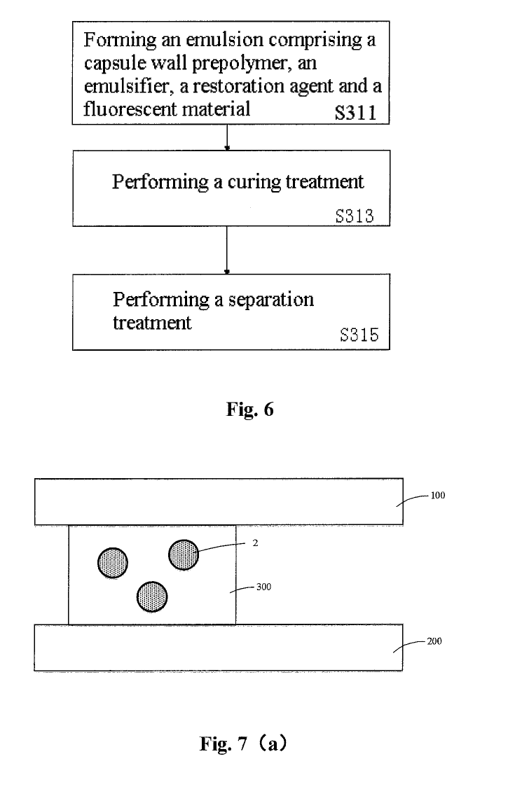

FIG. 6 is a flow chart showing the production method of an adhesive according to an example of the present invention. As shown in FIG. 6, in an example, step S31 for forming the capsule may comprise the following steps:

S311. Forming an emulsion comprising a capsule wall prepolymer, an emulsifier, a restoration agent and a fluorescent material;

S313. Performing a curing treatment;

S315. Performing a separation treatment.

Herein, “prepolymer” is a material which is able to further react to form a polymer, and “polymer” includes long-chain soluble and/or fusible molecules with repeated units.

In an example, a thermocuring method may be used for curing. In this case, the method for producing the adhesive according to the example of the present invention may specifically comprise the following processes.

A capsule wall prepolymer, an emulsifier, a restoration agent, a fluorescent material, distilled water and others are mixed to form an emulsion. The thermocuring agent is added to the emulsion. The emulsion with added thermocuring agent is warmed to 60° C., and reacted for 2 to 3 hours, to perform a thermocuring reaction. Acid such as acetic acid or diluted hydrochloric acid is added to the materials after the thermocuring reaction, to adjust the pH thereof to acid environment (e.g., adjusting the pH to 3). Then, after washing, filtration, and drying, capsules with self-restoring function are obtained. Thereafter, capsules and curing agent may be incorporated into the adhesive substrate, and distributed in the adhesive substrate (for example, distributed uniformly) by stirring.

In an example, the photocuring method may be used for curing. In this case, the method for producing the adhesive according to the example of the present invention may specifically comprise the following processes.

A capsule wall prepolymer, an emulsifier, a restoration agent, a fluorescent material, distilled water or others are mixed to form an emulsion. The photocuring agent is added to the emulsion. The emulsion with added photocuring agent is irradiated with ultraviolet light (wavelength ranging from 250 to 380 nm), and then react for 15 to 30 minutes, to perform a photocuring reaction. Acid such as acetic acid or diluted hydrochloric acid is added to the materials after the thermocuring reaction, to adjust the pH thereof to acid environment (e.g., adjusting the pH to 3). Then, after washing, filtration, and drying, capsules with self-restoring function are obtained. Thereafter, capsules and curing agent may be incorporated into the adhesive substrate, and distributed in the adhesive substrate by stirring.

Moreover, the capsule may also be formed by an in-situ emulsion method.

The restoration agent may comprise at least one of an epoxy resin, a vinyl ester resin, polymethyl methacrylate and cyclopentadiene. The capsule wall may comprise a urea-aldehyde resin, that is, the capsule wall prepolymer is a urea-aldehyde resin prepolymer. In view of better dissolution into the restoration agent, the fluorescent material may comprise an organic fluorescent material with good miscibility with the restoration agent. For example, the organic fluorescent materials may include at least one of fluorescein (C₂₀H₁₂O₅), Nile red (C₂₀H₁₈N₂O₂) and an aggregation-induced emission (AIE) fluorescent compound.

The example of the present invention further provides a display device, which includes the adhesive described above. In an example, the display device comprises a first substrate and a second substrate provided oppositely as well as the adhesive provided between the first substrate and the second substrate. The display device may be device with display function, such as a display panel, a display, a TV, a pad, a cell phone, a navigator and the like, which is not limited in the present disclosure.

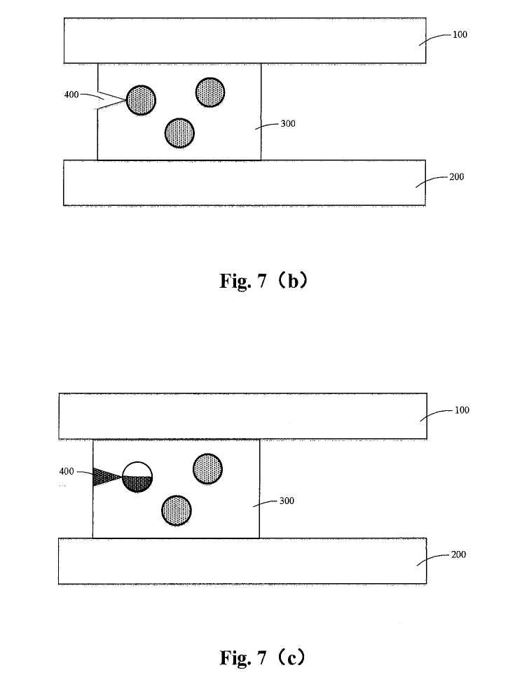

FIG. 7 is a schematic diagram of a display device according to an example of the present invention. FIG. 7 exemplify the structure that the display device comprises a first substrate and a second substrate provided oppositely as well as a bonding layer provided between the first substrate and the second substrate, wherein the bonding layer comprises the above described adhesive.

FIG. 7 (a) is a schematic diagram of a display device of an example in the present invention. As shown in FIG. 7 (a), the display device comprises a first substrate 100 and a second substrate 200 provided oppositely as well as a bonding layer 300 provided between the first substrate 100 and the second substrate 200. The bonding layer 300 comprises the adhesive according to an example of the present invention, which adhesive comprises a capsule 2 containing the restoration agent.

FIG. 7 (b) shows the situation that the adhesive of the display device is damaged. As shown in FIG. 7 (b), damage 400 is generated at the bonding layer.

FIG. 7 (c) shows the situation that the damage in the adhesive of the display device is restored. The damage causes the break of the capsule, and then the restoration agent flows out from the capsule. Then the polymerization reaction of the restoration agent occurs, thereby the crack at damage 400 can be restored.

The examples of the present invention provide technical solutions to solve the technical problem in the prior art such as the easy occurrence of local damage in the adhesive, such as the seal agent, thereby resulting in reduction of reliability, and provide an adhesive comprising a restoration agent-containing capsule, which may be used to achieve the self-restoration of the damage in an adhesive, such as a seal agent, improving the reliability of the adhesive. Further, the production method of the adhesive in the example of the present invention is simple, and would not result in additional process equipment and thus additional costs. Moreover, according to the position changing of the fluorescent material in the microcapsule, the stress-bearing-point and the crack position of the adhesive may be detected.

Certain examples have been described, which examples are represented in the way of examples, and are not aimed to limit the scope of the present invention. Actually, the new example described here may be implemented in various other forms. Moreover, various omission, replacement, and modification may be made to the examples as described herein without departing the spirit of the present invention. The appended claims and the equivalent thereof are intended to cover such forms or modifications that fall into the scope and the spirit of the present invention.

We claim:

1. An adhesive comprising an adhesive substrate, wherein the adhesive further comprises a capsule comprising a restoration agent and a capsule wall surrounding the restoration agent.

2. The adhesive according to claim 1, further comprising a catalyst provided in the adhesive substrate, which catalyst is used for catalyzing a polymerization reaction of the restoration agent.

3. The adhesive according to claim 1, wherein the restoration agent includes at least one of an epoxy resin, a vinyl ester resin, polymethyl methacrylate, and cyclopentadiene.

4. The adhesive according to claim 1, wherein the capsule wall comprises a urea-aldehyde resin.

5. The adhesive according to claim 1, wherein the capsule further comprises a fluorescent material.

6. The adhesive according to claim 5, wherein the fluorescent material comprises at least one of fluorescein, Nile red, and an aggregation-induced emission fluorescent compound.

7. The adhesive according to claim 1, wherein the adhesive substrate comprises a resin, an oligomer, a photoinitiator, and a curing agent.

8. The adhesive according to claim 7, wherein the curing agent has a mass percentage of 0.1 to 5 wt % in the adhesive.

9. The adhesive according to claim 1, wherein the capsule has a mass percentage of 0.5 to 15 wt % in the adhesive.

10. The adhesive according to claim 1, wherein the capsule has a particle size ranging from 10 to 100 nm.

11. A display device comprising the adhesive according to claim 1.

12. The display device according to claim 11, wherein the display device comprises a first substrate and a second substrate provided oppositely as well as the adhesive provided between the first substrate and the second substrate.

13. A production method of the adhesive according to claim 1, comprising
forming an adhesive substrate, and
providing a capsule in the adhesive substrate, which capsule comprises a restoration agent and a capsule wall surrounding the restoration agent.

14. The production method according to claim 13, wherein the production method further comprises incorporating a catalyst into the adhesive substrate, which catalyst is used for catalyzing a polymerization reaction of the restoration agent.

15. The production method according to claim 13, wherein the capsule further comprises a fluorescent material, and wherein providing a capsule in the adhesive substrate comprises:
forming the capsule; and
incorporating the capsule into the adhesive substrate.

16. The production method according to claim 15, wherein forming the capsule comprises:
forming an emulsion comprising a capsule wall prepolymer, an emulsifier, a restoration agent, and a fluorescent material;
performing a curing treatment; and
performing a separation treatment.

17. The production method according to claim 16, wherein performing a curing treatment comprises:
adding a thermocuring agent; and
curing for 2 to 3 hours under a condition of 60° C.

18. The production method according to claim 16, wherein performing a curing treatment comprises:
adding a photocuring agent; and
curing for 15 to 30 minutes under a condition of ultraviolet irradiation.

19. The production method according to claim 16, wherein forming the capsule comprises applying an in-situ emulsion method.

20. The production method according to claim 16, wherein
the restoration agent comprises at least one of an epoxy resin, a vinyl ester resin, polymethyl methacrylate and cyclopentadiene;
the capsule wall prepolymer comprises a urea-aldehyde resin prepolymer; and
the fluorescent material comprises at least one of fluorescein, Nile red, and an aggregation-induced emission fluorescent compound.
